(19) United States
(12) Patent Application Publication
(10) Pub. No.: US 2017/0336908 A1
(43) Pub. Date: Nov. 23, 2017

(54) TOUCH DISPLAY APPARATUS AND TOUCH DETECTION CIRCUIT THEREOF

(71) Applicant: INTEGRATED SOLUTIONS TECHNOLOGY INC., TAIPEI CITY (TW)

(72) Inventors: JIE LI, SHENZHEN (CN); WEI-TE LEE, TAIPEI CITY (TW)

(21) Appl. No.: 15/379,826

(22) Filed: Dec. 15, 2016

(30) Foreign Application Priority Data
May 23, 2016 (CN) 201610347399.X

(51) Int. Cl. G06F 3/041

(52) U.S. Cl. CPC G06F 3/0416; G06F 3/0412

(57) ABSTRACT

A touch display apparatus comprises a touch panel and a control circuit. The control circuit comprises a touch detection circuit, a buffer, a first switch, a second switch, a plurality of vertical controllers and a plurality of horizontal controllers. In a first period, the first switch is coupled to the touch detection circuit, and the plurality of vertical controllers and the plurality of horizontal controllers are reset. In a second period, the first switch is coupled to the buffer, and the touch detection circuit detects a touch voltage. In this way, the touch display apparatus enables pixel units on the display panel to be set at the same voltage so as to avoid incorrect action of the pixel units. The touch display apparatus also increases a proportion of a change amount of a sampling charge change generated by touching a touch capacitor for improving detection sensitivity.

### BACKGROUND OF THE INVENTION

### 1. Field of the Invention

The instant disclosure relates to a touch detection circuit; in particular, to a touch detection circuit for use in a touch display apparatus.

### 2. Description of Related Art

Touch displays are now very popular for input into display apparatus, and provide users with an intuitive, fast and simple operation interface and real-time display functions. They have become popular in electronic products nowadays.

### SUMMARY OF THE INVENTION

An exemplary embodiment of the instant disclosure provides a touch detection circuit comprising a sampling circuit, a buffer and an output circuit, wherein an input end of the sampling circuit detects a touch voltage, a first input end of the buffer is coupled to an output end of the sampling circuit, an output end of the buffer is coupled to a second input end of the buffer, an input end of the output circuit is coupled to the output end of the buffer, and an output end of the output circuit outputs a sampling voltage. In a first period, the sampling circuit is reset and the output circuit outputs a reset voltage. In a second period, the sampling circuit detects the touch voltage and the output circuit outputs the sampling voltage.

An exemplary embodiment of the instant disclosure provides a touch display apparatus comprising a touch panel and a control circuit. The touch panel has a plurality of horizontal electrode lines and a plurality of vertical electrode lines, wherein the plurality of horizontal electrode lines is electrically isolated from the plurality of vertical electrode lines. The control circuit comprises a touch detection circuit, a buffer, a first switch, a second switch, a plurality of vertical controllers and a plurality of horizontal controllers, wherein an input end of the buffer is coupled to an input end of the touch detection circuit, one end of the first switch is coupled to the input end of the touch detection circuit or an output end of the buffer, one end of the second switch is coupled to the input end of the touch detection circuit, the plurality of vertical controllers are coupled to the plurality of vertical electrode lines and the other end of the second switch and the plurality of horizontal controllers are coupled to the plurality of horizontal electrode lines and the other end of the first switch. In a first period, the first switch is coupled to the input end of the touch detection circuit, and the plurality of vertical controllers and the plurality of horizontal controllers are reset. In the second period, the first switch is coupled to the output end of the buffer, and the touch detection circuit detects the touch voltage.

To sum up, the touch detection circuit of the present invention can be used in a touch display apparatus having a touch detection function and the touch display apparatus of the present invention can be used in any electronic equipment having touch detection and display function.

For further understanding of the instant disclosure, reference is made to the following detailed description illustrating the embodiments of the instant disclosure. The description is only for illustrating the instant disclosure, not for limiting the scope of the claims.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a circuit diagram of a touch detection circuit of one embodiment of the present invention.

FIG. 2 shows a circuit diagram of a touch detection circuit of one embodiment of the present invention in a first period.

FIG. 3 shows a circuit diagram of a touch detection circuit of one embodiment of the present invention in a second period.

FIG. 4 shows a touch detection time diagram of a touch detection circuit of one embodiment of the present invention.

FIG. 5 shows a circuit diagram of a touch display apparatus of one embodiment of the present invention.

FIG. 6 shows a circuit diagram of a touch display apparatus of one embodiment of the present invention in a first period.

FIG. 7 shows a circuit diagram of a touch display apparatus of one embodiment of the present invention in a second period.

FIG. 8 shows a circuit diagram of a touch display apparatus of the other embodiment of the present invention in a second period.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

It will be understood that, although the terms first, second, third, and the like, may be used herein to describe various elements, but these elements should not be limited by these terms. These terms are only to distinguish one element, component, region, layer, or section from another element, component, region, layer, or section discussed below. Thus, a first element, component, region, layer, or section discussed below could be termed a second element, component, region, layer, or section without departing from the teachings of the instant disclosure. As used herein, the term “and/or” includes any and all combinations of one or more of the associated listed items.

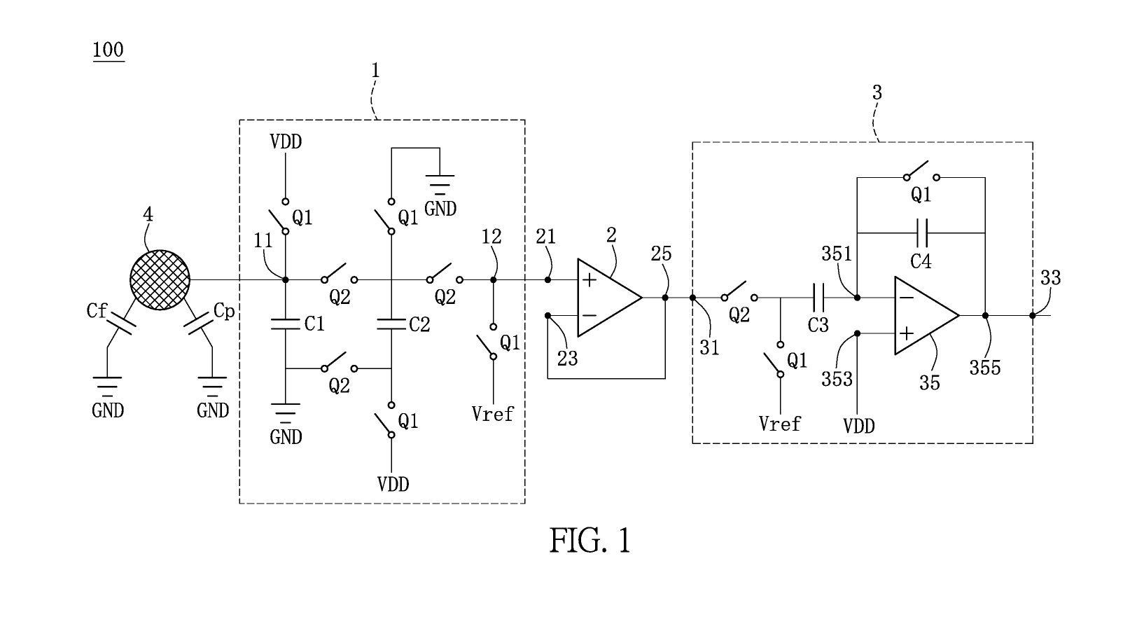

FIG. 1 shows a circuit diagram of a touch detection circuit of one embodiment of the present invention. The touch detection circuit 100 comprises: a sampling circuit 1, a first buffer 2 and an output circuit 3. In one embodiment, an input end 11 of the sampling circuit 1 which is an input end 11 of the touch detection circuit 100 is coupled to a touch display point 4 to detect a touch voltage, an output end 12 of the sampling circuit 1 outputs a sampling voltage. The sampling circuit 1 comprises a first capacitor C1, a second capacitor C2, a plurality of first switches Q1 and a plurality of second switches Q2. A voltage end VDD which provides a reset voltage is coupled to a first end of the first capacitor C1, a ground end GND is coupled to a second end of the first capacitor C1, a first end of the second capacitor C2 is coupled to the second end of the first capacitor C1 and the voltage end VDD, a second end of the second capacitor C2 is coupled to the first end of the first capacitor C1 and the ground end GND. The plurality of first switches Q1 are coupled between the voltage end VDD and the first end of the first capacitor C1, the voltage end VDD and the first end of the second capacitor C2, the second end of the second capacitor C2 and the ground end GND, and a reference voltage end Vref and an output end 12 of the sampling circuit 12. The plurality of second switches are coupled between the first end of the first capacitor C1 and the second end of the second capacitor C2, the second end of the first capacitor C1 and the first end of the second capacitor C2, and the second end of the second capacitor C2 and the output end 12 of the sampling circuit 1.

When the plurality of first switches Q1 are turned on and the plurality of second switches Q2 are turned off, the first capacitor C1 of the sampling circuit 1 and a touch capacitor Cf and a parasitic capacitor Cp of the touch display point 4 are reset to the reset voltage, the second capacitor C2 of the sampling circuit 1 is reset to negative the reset voltage, and the output end 12 of the sampling circuit 1 is coupled to the reference voltage end to output a reference voltage, where the reset voltage is larger than the reference voltage. It is worth noting that a polarity of the second capacitor C2 is opposite to that of the first capacitor C1, the touch capacitor Cf and the parasitic capacitor Cp. When the plurality of first switches Q1 are turned off and the plurality of second switches Q2 are turned on, a sum of electric charge between the first capacitor C1, the second capacitor C2, the touch capacitor Cf and the parasitic capacitor Cp generates the sampling voltage and the output end 12 of the sampling circuit 1 outputs the sampling voltage.

In one embodiment, a first input end 21 of the first buffer 2 is coupled to the output end 12 of the sampling circuit 1, and an output end 25 of the first buffer 2 is coupled to a second input end 23 of the first buffer 2. When the plurality of first switches Q1 are turned on and the plurality of second switches Q2 are turned off, the first input end 21 of the first buffer 2 receives the reference voltage and the output end 25 of the first buffer 2 outputs the reference voltage. When the plurality of first switches Q1 are turned off and the plurality of second switches Q2 are turned on, the first input end 21 of the first buffer 2 receives the sampling voltage and the output end 25 of the first buffer 2 outputs the sampling voltage.

In one embodiment, an input end of the output circuit 3 is coupled to the output end 25 of the first buffer 2, and the output end 33 of the output circuit 3 outputs the sampling voltage. The output circuit 3 comprises a third capacitor C3, a fourth capacitor C4, an amplifier 35, a plurality of first switches Q1 and a second switch Q2. A first end of the third capacitor C3 is coupled to the reference voltage end Vref and an input end 31 of the output circuit 3, a second end of the third capacitor C3 is coupled to a first input end 351 of the amplifier 35 and a first end of the fourth capacitor C4, a second end of the fourth capacitor C4 is coupled to an output end 355 of the amplifier 35, and a second input end 353 of the amplifier 35 is coupled to the voltage end VDD. The output end 355 of the amplifier 35 is the output end 33 of the output circuit 3. The plurality of first switches Q1 are coupled between the first end of the third capacitor C3 and the reference voltage end Vref, and the first end of the fourth capacitor C4 and the second end of the fourth capacitor C4. The second switch Q2 is coupled between the input end 31 of the output circuit 3 and the first end of the third capacitor C3.

When the plurality of first switches Q1 are turned on and the second switches Q2 are turned off, the output end 33 of the output circuit 3 outputs the reset voltage. When the plurality of first switches Q1 are turned off and the second switches Q2 are turned on, the input end 31 of the output circuit 3 receives the sampling voltage, the output end 355 of the amplifier 35 outputs the sampling voltage which has been amplified by the amplifier 35.

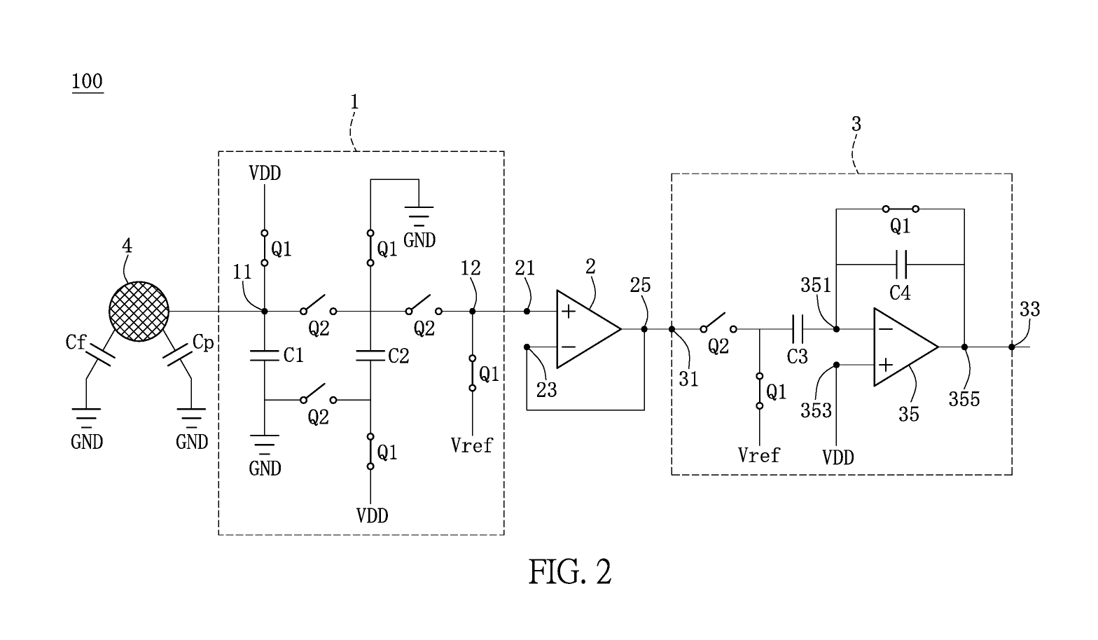

FIG. 2 shows a circuit diagram of a touch detection circuit of one embodiment of the present invention in a first period. In one embodiment, the plurality of first switches Q1 are turned on and the plurality of second switches Q2 are turned off in the first period P1, the first capacitor C1 of the sampling circuit 1 and a touch capacitor Cf and a parasitic capacitor Cp of the touch display point 4 are reset to the reset voltage, the second capacitor C2 of the sampling circuit 1 is reset to the negative of the reset voltage, where the polarity of the second capacitor C2 is opposite to that of the first capacitor C1, the touch capacitor Cf and the parasitic capacitor Cp. The output end 12 of the sampling circuit 1 outputs the reference voltage to the first input end 21 of the first buffer 2, the output end 25 of the first buffer 21 outputs the reference voltage, and the output end 33 of the output circuit 3 outputs the reset voltage.

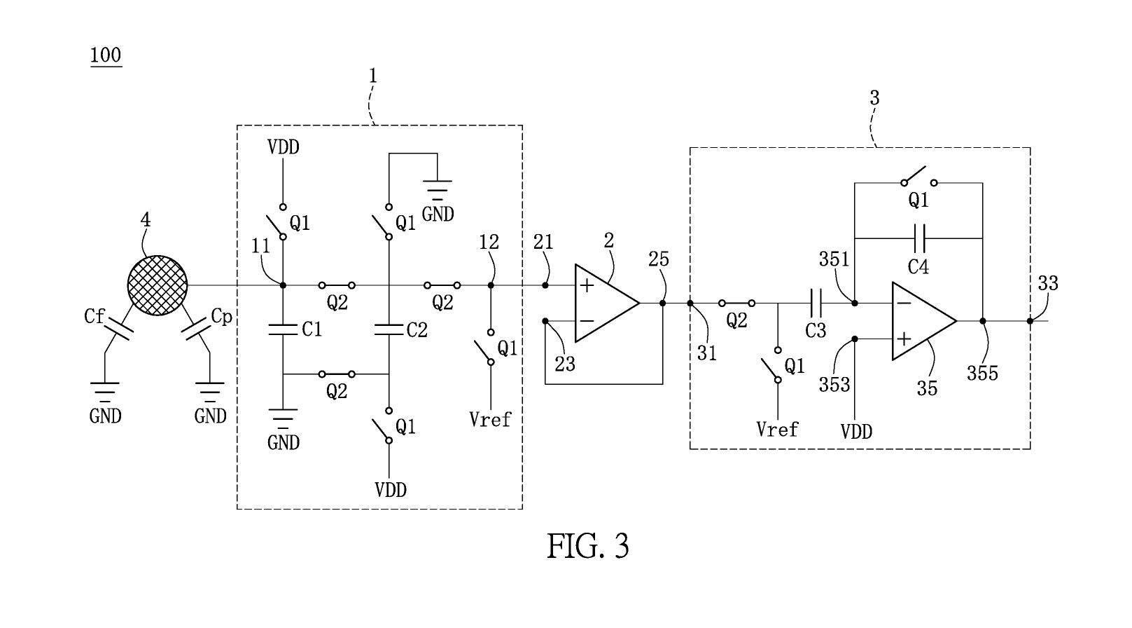

FIG. 3 shows a circuit diagram of a touch detection circuit of one embodiment of the present invention in a second period. In one embodiment, the plurality of first switches Q1 are turned off and the plurality of second switches Q2 are turned on in the second period P2, the sum of electric charge between the first capacitor C1, the second capacitor C2, the touch capacitor Cf and the parasitic capacitor Cp generates the sampling voltage. The output end 12 of the sampling circuit 1 outputs the sampling voltage. The first input end 21 of the first buffer 2 receives the sampling voltage, and the output end 25 of the first buffer 2 outputs the sampling voltage. The input end 31 of the output circuit 3 receives the sampling voltage, and the output end 355 of the amplifier 35 outputs the sampling voltage which has been amplified by the amplifier 35.

In one embodiment, the first period P1 and the second period P2 are executed alternately and repeatedly. In the first period P1, the plurality of first switches Q1 are turned on and the plurality of second switches Q2 are turned off. The first capacitor C1 of the sampling circuit 1, and a touch capacitor Cf and a parasitic capacitor Cp of the touch display point 4 are reset to the reset voltage, the second capacitor C2 of the sampling circuit 1 is reset to the negative of the reset voltage, where the polarity of the second capacitor C2 is opposite to that of the first capacitor C1, the touch capacitor Cf and the parasitic capacitor Cp. The output end 12 of the sampling circuit 1 outputs the reference voltage to the first input end 21 of the first buffer 2, the output end 25 of the first buffer 21 outputs the reference voltage, and the output end 33 of the output circuit 3 outputs the reset voltage. Thus, the sampling circuit 1 is reset and the output circuit 3 outputs the reset voltage. In the second period P2, the plurality of first switches Q1 are turned off and the plurality of second switches Q2 are turned on. The sum of electric charge between the first capacitor C1, the second capacitor C2, and the touch capacitor Cf and the parasitic capacitor Cp generates the sampling voltage, and the output end 12 of the sampling circuit 1 outputs the sampling voltage. The first input end 21 of the first buffer 2 receives the sampling voltage, and the output end 25 of the first buffer 2 outputs the sampling voltage. The input end 31 of the output circuit 3 receives the sampling voltage, and the output end 355 the amplifier 35 outputs the sampling voltage which has been amplified by the amplifier 35. Thus, the sampling circuit 1 detects the touch voltage, and the output circuit 3 amplifies and outputs the sampling voltage.

For example, in the second period P2, the plurality of first switches Q1 are turned off and the plurality of second switches Q2 are turned on. When the touch display point 4 is not touched, the first capacitor C1 of the sampling circuit 1 and a touch capacitor Cf and a parasitic capacitor Cp of the touch display point 4 are reset to the reset voltage and the second capacitor C2 of the sampling circuit 1 is reset to negative the reset voltage. Due to the sum of electric charge, the touch voltage is equal to 0V. The sampling circuit 1 outputs the sampling voltage of 0V, and the output end 33 of the output circuit 3 outputs the sampling voltage.

For example, in the second period P2, the plurality of first switches Q1 are turned off and the plurality of second switches Q2 are turned on. When the touch display point 4 is touched, the electric charge of the first capacitor C1, a touch capacitor Cf and a parasitic capacitor Cp are increased. The sum of electric charge generates the touch voltage which is larger than the reference voltage and smaller than the reset voltage, and thus the sampling circuit 1 outputs the sampling voltage which is larger than the reference voltage and smaller than the reset voltage and then the output end 33 of the output circuit 3 outputs the sampling voltage.

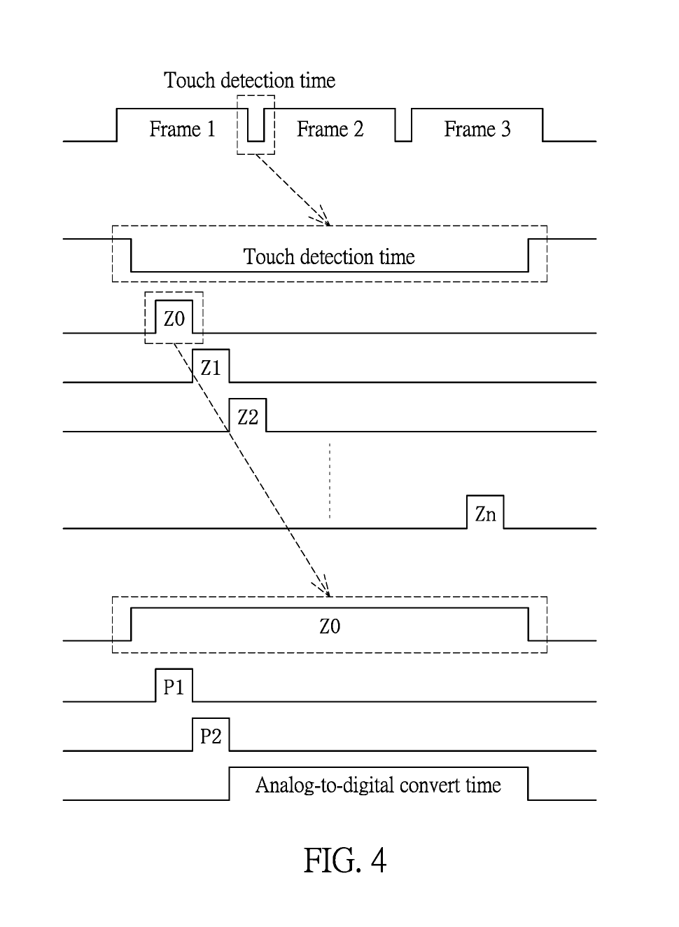

FIG. 4 shows a touch detection time diagram of a touch detection circuit of one embodiment of the present invention. The top of the FIG. 4 shows that the touch detection circuit of one embodiment of the present invention uses a detection time between two image frames to detect the touch display point. The middle of FIG. 4 shows that the touch detection circuit of one embodiment of the present invention detects the touch display points Z0, Z1, Z2, . . . Zn sequentially in the detection time. The bottom of FIG. 4 shows that the touch detection circuit of one embodiment of the present invention detects the touch display point Z0 in the detection time. As an example in the bottom of FIG. 4, the detection time for detecting the touch display point Z0 includes the first period P1 in which the sampling circuit 1 is reset and the output circuit 3 outputs the reset voltage, the second period P2 in which the sampling circuit 1 detects the touch voltage and the output circuit 3 outputs the sampling voltage, and an analog-to-digital convert time for converting signal.

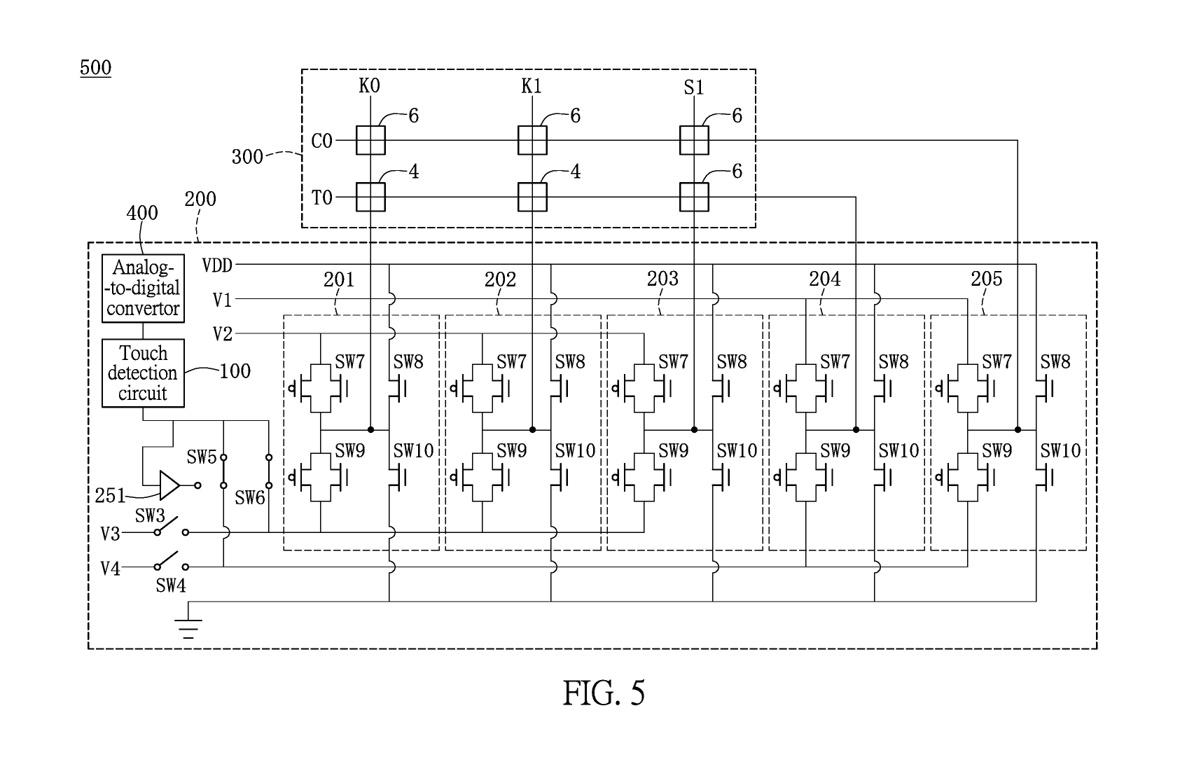

FIG. 5 shows a circuit diagram of a touch display apparatus of one embodiment of the present invention, which represents the circuit in the detection time. In one embodiment, the touch display apparatus 500 comprises: a touch panel 300 and a control circuit 200. The touch panel 300 includes a plurality of horizontal electrode lines C0, T0 and a plurality of vertical electrode lines K0, K1, S1, wherein the plurality of horizontal electrode lines C0, T0 are electrically isolated from the plurality of vertical electrode lines K0, K1, S1. Points which are formed by the horizontal electrode line C0 intersected with the plurality of vertical electrode lines K0, K1, S1 are display points 6, points which are formed by the horizontal electrode line T0 intersected with the plurality of vertical electrode lines K0, K1 are the touch display points 4, and point which is formed by the horizontal electrode line T0 intersected with the vertical electrode lines S1 is the display point 6. The control circuit 200 comprises: the touch detection circuit 100, a second buffer 251, a third switch SW3, a fourth switch SW4, a fifth switch SW5, a sixth switch SW6, a plurality of vertical controllers 201, 202, 203, a plurality of horizontal controllers 204, 205, and an analog-to-digital converter 400. The plurality of horizontal controllers 204, 205 are coupled to the plurality of horizontal electrode lines C0, T0, one end of the fourth switch SW4 and one end of the fifth switch SW5. The plurality of vertical controllers 201, 202, 203 are coupled to the plurality of vertical electrode lines K0, K1, S1, one end of the third switch SW3 and one end of the sixth switch SW6. The other end of the third switch SW3 is coupled to a third voltage V3. The other end of the fourth switch SW4 is coupled to a fourth voltage V4. The other end of the fifth switch SW5 is coupled to the input end of the touch detection circuit 100 or an output end of the second buffer 251. The other end of the sixth switch SW6 is coupled to the input end of the touch detection circuit 100. An input end of the second buffer 251 is coupled to the input end of the touch detection circuit 100. An input end of the analog-to-digital converter 400 is coupled to an output end of the touch detection circuit 100. In addition, the plurality of vertical controllers 201, 202, 203 and the plurality of horizontal controllers 204, 205 have a seventh switch SW7, an eighth switch SW8, a ninth switch SW9, and a tenth switch SW10. The third switch SW3, the fourth switch SW4, the fifth switch SW5, the sixth switch SW6, the seventh switch SW7, the eighth switch SW8, the ninth switch SW9 and the tenth switch SW10 are analog switches, such as bipolar junction transistors (BJT), metal-oxide-semiconductor field-effect transistor (MOSFET), or any unit, element or device which can equal to an analog switch. The touch display apparatus 500 of the present invention only illustrates a purpose of the present invention and does not restrict the present invention. Those skilled in the art can design a size and a shape of the touch panel, and increase the number of the vertical and the horizontal controllers and the number of the vertical and the horizontal electrode lines according to an actual application.

As an example in the vertical controller 201, one end of the seventh switch SW7 is coupled to a second voltage V2, one end of the eighth switch SW8 is coupled to the voltage end VDD to be supplied with the reset voltage. The other end of the seventh switch SW7 is coupled to the other end of the eighth switch SW8, one end of the ninth switch SW9, one end of the tenth switch SW10 and the vertical electrode line K0. The other end of the ninth switch SW9 is coupled to one end of the third switch SW3 and one end of the sixth switch SW6. The other end of the tenth switch SW10 is coupled to the ground end GND. The vertical controllers 202, 203 have the same structure, and thus it is not repeated here.

As an example in the horizontal controller 204, one end of the seventh switch SW7 is coupled to a first voltage V1, one end of the eighth switch SW8 is coupled to the voltage end VDD to be supplied with the reset voltage. The other end of the seventh switch SW7 is coupled to the other end of the eighth switch SW8, one end of the ninth switch SW9, one end of the tenth switch SW10 and the horizontal electrode line T0. The other end of the ninth switch SW9 is coupled to one end of the fourth switch SW4 and one end of the fifth switch SW5. The other end of the tenth switch SW10 is coupled to the ground end. The horizontal controller 205 has the same structure, and thus it is not repeated here.

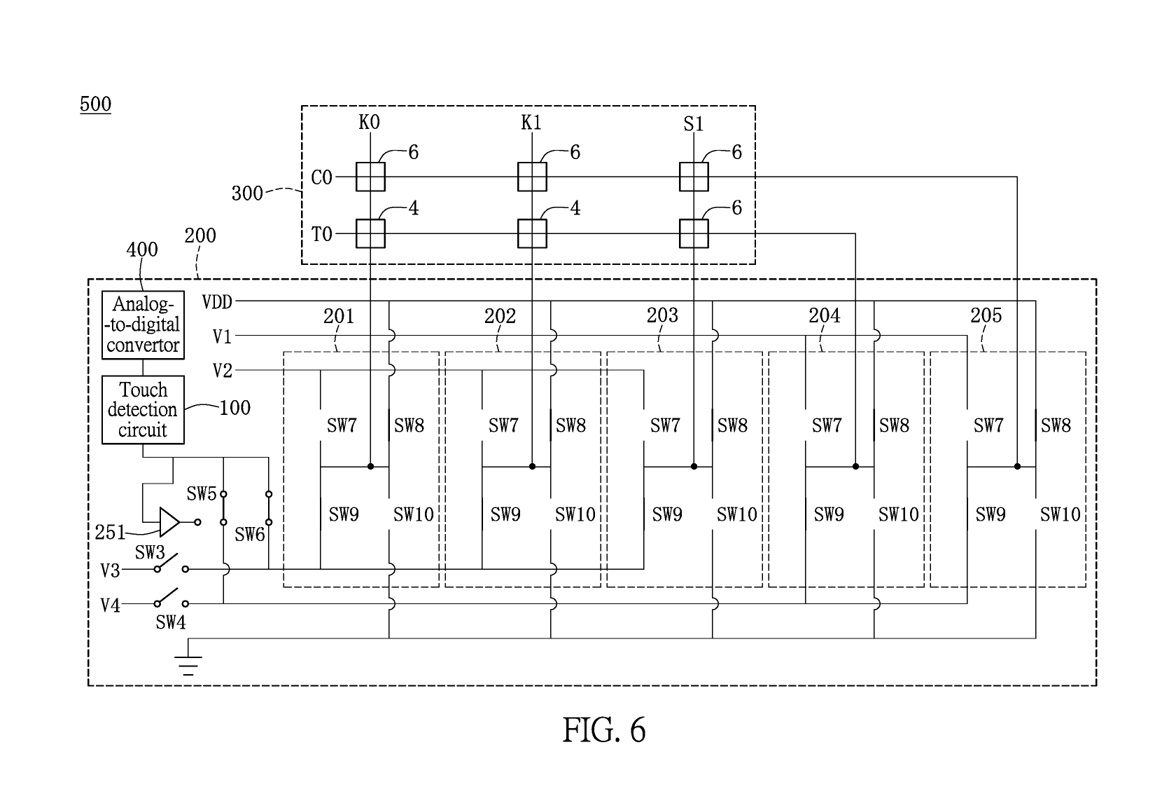

FIG. 6 shows a circuit diagram of a touch display apparatus of one embodiment of the present invention in a first period, which represents a circuit state of touch detection in the first period P1. In the touch display apparatus 500, a connection of the seventh switch SW7, the eighth switch SW8, the ninth switch SW9 and the tenth switch SW10 represents that a switch is turned on, and a disconnection of the seventh switch SW7, the eighth switch SW8, the ninth switch SW9 and the tenth switch SW10 represents that a switch is turned off. In one embodiment, the seventh switches SW7 and the tenth switches SW10 of the plurality of the vertical controllers 201, 202, 203 are turned off, and the eighth switches SW8 and the ninth switches SW9 of the plurality of the vertical controllers 201, 202, 203 are turned on. The seventh switches SW7 and the tenth switches SW10 of the plurality of the horizontal controllers 204, 205 are turned off, and the eighth switches SW8 and the ninth switches SW9 of the plurality of the horizontal controllers 204, 205 are turned on. The third switch SW3 and the fourth switch SW4 are turned off. The fifth switch SW5 is turned on to electrically connect the input end of the touch detection circuit 100 with the an end of the ninth switches SW9 of the plurality of the horizontal controllers 204, 205. The sixth switch SW6 is turned on to electrically connect the input end of the touch detection circuit 100 with the other end of the ninth switches SW9 of the plurality of the vertical controllers 201, 202, 203. At this time, the touch display apparatus 500 performs a potential or voltage reset, so that the pixel units of the touch display point 4 and display point 6 are set to the same potential or voltage to avoid incorrect action of the pixel units. In addition, in the touch detection circuit 100 as shown in FIG. 2, the sampling circuit 1 is reset and the output circuit 3 outputs the reset voltage.

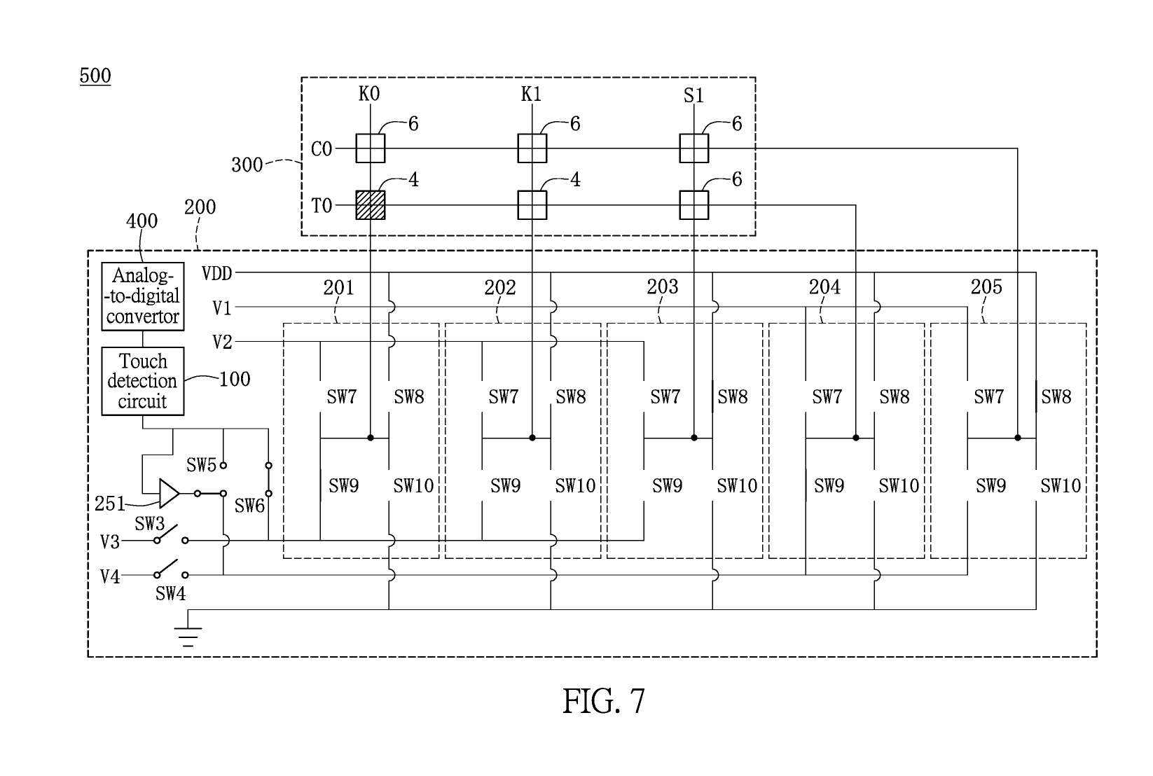

FIG. 7 shows a circuit diagram of a touch display apparatus of one embodiment of the present invention in a second period, which represents a circuit state of touch detection in the second period P2. As an example to perform touch detection of the touch display point 4 intersected by the horizontal electrode line T0 and the vertical electrode line K0, the seventh switch SW7, the eighth switch SW8 and the tenth switch SW10 of the vertical controller 201 are turned off, and the ninth switch SW9 of the vertical controller 201 is turned on. The seventh switch SW7, the eighth switch SW8, the ninth switch SW9 and the tenth switch SW10 of the vertical controller 202 are turned off. The seventh switch SW7, the ninth switch SW9 and the tenth switch SW10 of the vertical controller 203 are turned off, and the eighth switch SW8 of the vertical controller 203 is turned on. The seventh switch SW7, the eighth switch SW8 and the tenth switch SW10 of the horizontal controller 204 are turned off, and the ninth switch SW9 of the horizontal controller 204 is turned on. The seventh switch SW7, the ninth switch SW9 and the tenth switch SW10 of the horizontal controller 205 are turned off, and the eighth switch SW8 of the horizontal controller 205 is turned on. The third switch SW3 and the fourth switch SW4 are turned off. The fifth switch SW5 is turned on to electrically connect the output end of the second buffer 251 with the other end of the ninth switch SW9 of the horizontal controller 204. The sixth switch SW6 is turned on to electrically connect the input end of the touch detection circuit 100 with the other end of the ninth switch SW9 of the vertical controller 201. The eighth switches SW8 of the vertical controller 203 and the horizontal controller 205 are turned on to connect to the voltage end VDD, and thus the pixel unit of the display point 6 intersected by the horizontal electrode line C0 and the vertical electrode line S1 is set to the same potential or voltage to avoid incorrect action of the pixel unit. At the same time, the second buffer 251 causes a voltage variation between a lower plate and a higher plate of the parasitic capacitor Cp formed by the horizontal electrode line T0 and the vertical electrode line K0 to decrease an electric charge amount stored in the parasitic capacitor Cp, so as to increase a proportion in a change amount of a sampling charge change generated by touching the touch capacitor Cf for improving detection sensitivity. In addition, in the touch detection circuit 100 as shown in FIG. 3, the sampling circuit 1 detects the touch voltage and the output circuit 3 amplifies and outputs the sampling voltage in the second period P2.

When the touch detection of the touch display point 4 intersected by the horizontal electrode line T0 and the vertical electrode line K1 is executed after the touch detection of the touch display point 4 intersected by the horizontal electrode line T0 and the vertical electrode line K0 finished, the touch display apparatus 500 as shown in FIG. 6 performs the potential or voltage reset, and the sampling circuit 1 is reset and the output circuit 3 outputs the reset voltage in the touch detection circuit 100 as shown in FIG. 2.

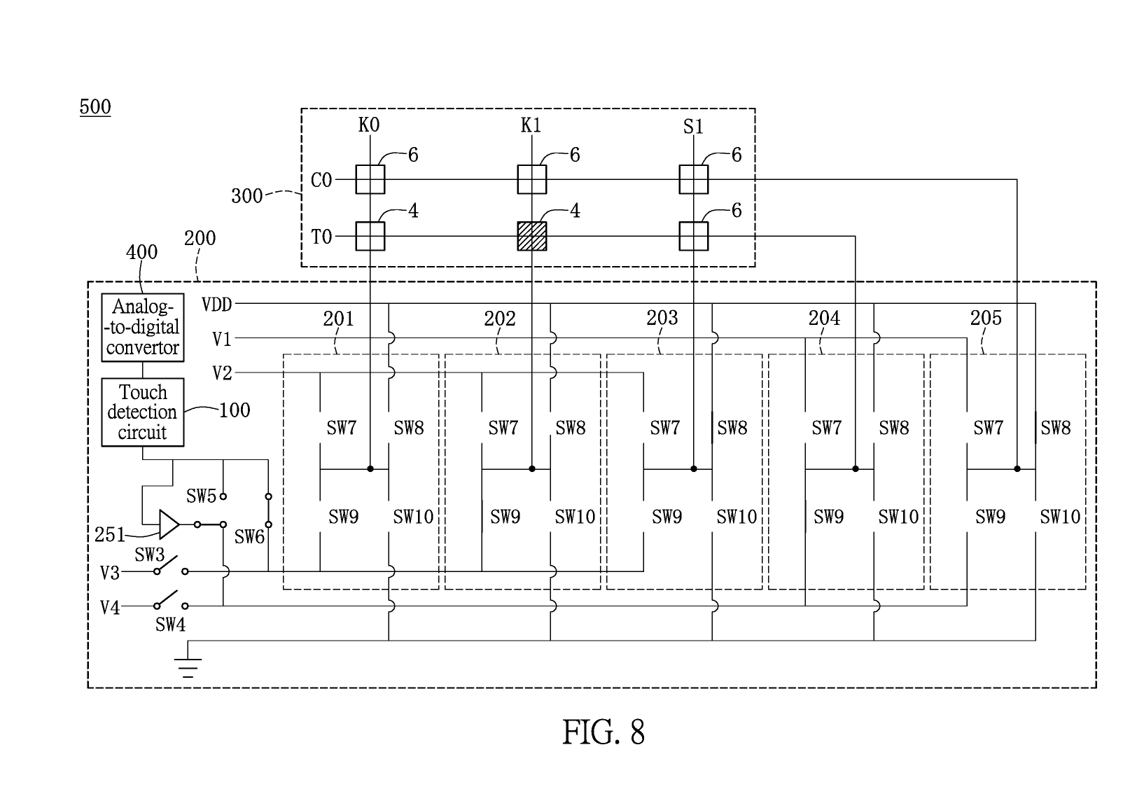

FIG. 8 shows a circuit diagram of a touch display apparatus of the other embodiment of the present invention in a second period, which represents the other circuit state of touch detection in the second period P2. As an example, to perform touch detection of the touch display point 4 intersected by the horizontal electrode line T0 and the vertical electrode line K1, the seventh switch SW7, the eighth switch SW8, the ninth switch SW9 and the tenth switch SW10 of the vertical controller 201 are turned off. The seventh switch SW7, the eighth switch SW8 and the tenth switch SW10 of the vertical controller 202 are turned off, and the ninth switch SW9 of the vertical controller 202 is turned on. The seventh switch SW7, the ninth switch SW9 and the tenth switch SW10 of the vertical controller 203 are turned off, and the eighth switch SW8 of the vertical controller 203 is turned on. The seventh switch SW7, the eighth switch SW8 and the tenth switch SW10 of the horizontal controller 204 are turned off, and the ninth switch SW9 of the horizontal controller 204 is turned on. The seventh switch SW7, the ninth switch SW9 and the tenth switch SW10 of the horizontal controller 205 are turned off, and the eighth switch SW8 of the horizontal controller 205 is turned on. The third switch SW3 and the fourth switch SW4 are turned off. The fifth switch SW5 is turned on to electrically connect the output end of the second buffer 251 with the other end of the ninth switch SW9 of the horizontal controller 204. The sixth switch SW6 is turned on to electrically connect the input end of the touch detection circuit 100 with the other end of the ninth switch SW9 of the vertical controller 202. The eighth switches SW8 of the vertical controller 203 and the horizontal controller 205 are turned on to connect to the voltage end VDD, and thus the pixel units of the display point 6 intersected by the horizontal electrode line C0 and the vertical electrode line S1 are set to the same potential or voltage to avoid incorrect action of the pixel units. In addition, in the touch detection circuit 100 as shown in FIG. 3, the sampling circuit 1 detects the touch voltage and the output circuit 3 amplifies and outputs the sampling voltage in the second period P2.

Based on the above-mentioned embodiments, the touch display apparatus and the touch detection circuit of the present invention can be used in electronic equipment including a touch panel, such as a tablet, a smart phone or any electronic equipment having a touch detection function.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A touch detection circuit, comprising:
a sampling circuit, an input end of the sampling circuit detecting a touch voltage;
a buffer, a first input end of the buffer coupled to an output end of the sampling circuit, an output end of the buffer coupled to a second input end of the buffer; and
an output circuit, an input end of the output circuit coupled to the output end of the buffer, an output end of the output circuit outputting a sampling voltage;
wherein the sampling circuit is reset and the output circuit outputs a reset voltage in a first period, the sampling circuit detects the touch voltage and the output circuit outputs the sampling voltage in a second period.

2. The touch detection circuit according to claim 1, wherein the sampling circuit comprises:
a first capacitor;
a second capacitor;
a plurality of first switches; and
a plurality of second switches;
wherein a voltage end is coupled to a first end of the first capacitor, a ground end is coupled to a second end of the first capacitor, a first end of the second capacitor is coupled to the second end of the first capacitor and the voltage end, a second end of the second capacitor is coupled to the first end of the first capacitor and the ground end, the plurality of first switches are coupled between the voltage end and the first end of the first capacitor, the voltage end and the first end of the second capacitor, the second end of the second capacitor and the ground end, and a reference voltage end and the output end of the sampling circuit, and the plurality of second switches are coupled between the first end of the first capacitor and the second end of the second capacitor, the second end of the first capacitor and the first end of the second capacitor, and the second end of the second capacitor and the output end of the sampling circuit.

3. The touch detection circuit according to claim 2, wherein the output circuit comprises:
a third capacitor;
a fourth capacitor;
an amplifier;
a plurality of third switches; and
a fourth switch;
wherein a first end of the third capacitor is coupled to the reference voltage end, a second end of the third capacitor is coupled to a first input end of the amplifier and a first end of the fourth capacitor, a second end of the fourth capacitor is coupled to an output end of the amplifier, a second input end of the amplifier is coupled to the voltage end, the plurality of third switches are coupled between the first end of the third capacitor and the reference voltage, and the first end of the fourth capacitor and the second end of the fourth capacitor, and the fourth switch is coupled between the input end of the output circuit and the first end of the third capacitor.

4. The touch detection circuit according to claim 3, wherein the plurality of first switches and the plurality of third switches are turned on and the plurality of second switches and the fourth switch are turned off in the first period, the plurality of first switches and the plurality of third switches are turned off and the plurality of second switches and the fourth switch are turned on in the second period.

5. A touch display apparatus, comprising:
a touch panel, having a plurality of horizontal electrode lines and a plurality of vertical electrode lines, wherein the plurality of horizontal electrode lines is electrically isolated from the plurality of vertical electrode lines; and
a control circuit, comprising:
a touch detection circuit;
a first buffer, an input end of the first buffer coupled to an input end of the touch detection circuit;
a first switch, one end of the first switch coupled to the input end of the touch detection circuit or an output end of the first buffer;
a second switch, one end of the second switch coupled to the input end of the touch detection circuit;
a plurality of vertical controllers, coupled to the plurality of vertical electrode lines and the other end of the second switch; and
a plurality of horizontal controllers, coupled to the plurality of horizontal electrode lines and the other end of the first switch;
wherein the first switch is coupled to the input end of the touch detection circuit and the plurality of vertical controllers and the plurality of horizontal controllers are reset in a first period, the first switch is coupled to the output end of the first buffer and the touch detection circuit detects the touch voltage in a second period.

6. The touch display apparatus according to claim 5, wherein the control circuit further comprises:
an analog-to-digital converter, coupled to an output end of the touch detection circuit.

7. The touch display apparatus according to claim 5, wherein each of the plurality of vertical controllers comprises:
a third switch, one end of the third switch coupled to a voltage end and the other end of the third switch coupled to a vertical electrode line; and
a fourth switch, one end of the fourth switch coupled to the vertical electrode line and the other end of the fourth switch coupled to the other end of the second switch.

8. The touch display apparatus according to claim 7, wherein each of the plurality of horizontal controllers comprises:
a fifth switch, one end of the fifth switch coupled to the voltage end and the other end of the fifth switch coupled to a horizontal electrode line; and
a sixth switch, one end of the sixth switch coupled to the horizontal electrode line and the other end of the sixth switch coupled to the other end of the first switch.

9. The touch display apparatus according to claim 8, wherein the first switch, the second switch, the third switch, the fourth switch, the fifth switch and the sixth switch are analog switches.

10. The touch display apparatus according to claim 9, wherein the first switch, the second switch, the third switch, the fourth switch, the fifth switch and the sixth switch are bipolar junction transistors (BJT) or metal-oxide-semiconductor field-effect transistors (MOSFET).

11. The touch display apparatus according to claim 8, wherein the touch detection circuit comprises:
a sampling circuit, an input end of the sampling circuit detecting a touch voltage;
a second buffer, a first input end of the second buffer coupled to an output end of the sampling circuit, an output end of the second buffer coupled to a second input end of the second buffer; and
an output circuit, an input end of the output circuit coupled to the output end of the second buffer, an output end of the output circuit outputting a sampling voltage;
wherein the sampling circuit is reset and the output circuit outputs a reset voltage in the first period, the sampling circuit detects the touch voltage and the output circuit outputs the sampling voltage in the second period.

12. The touch display apparatus according to claim 11, wherein the sampling circuit comprises:
a first capacitor;
a second capacitor;
a plurality of seventh switches; and
a plurality of eighth switches;
wherein the voltage end is coupled to a first end of the first capacitor,
a ground end is coupled to a second end of the first capacitor, a first end of the second capacitor is coupled to the second end of the first capacitor and the voltage end, a second end of the second capacitor is coupled to the first end of the first capacitor and the ground end, the plurality of seventh switches are coupled between the voltage end and the first end of the first capacitor, the voltage end and the first end of the second capacitor, the second end of the second capacitor and the ground end, and a reference voltage end and the output end of the sampling circuit, and the plurality of eighth switches are coupled between the first end of the first capacitor and the second end of the second capacitor, the second end of the first capacitor and the first end of the second capacitor, and the second end of the second capacitor and the output end of the sampling circuit.

13. The touch display apparatus according to claim 12, wherein
a third capacitor;
a fourth capacitor;
an amplifier;
a plurality of ninth switches; and
a tenth switch;
wherein a first end of the third capacitor is coupled to the reference voltage end, a second end of the third capacitor is coupled to a first input end of the amplifier and a first end of the fourth capacitor, a second end of the fourth capacitor is coupled to an output end of the amplifier, a second input end of the amplifier is coupled to the voltage end, the plurality of ninth switches are coupled between the first end of the third capacitor and the reference voltage, and the first end of the fourth capacitor and the second end of the fourth capacitor, and the tenth switch is coupled between the input end of the output circuit and the first end of the third capacitor.

14. The touch display apparatus according to claim 13, wherein the plurality of seventh switches and the plurality of ninth switches are turned on and the plurality of eighth switches and the tenth switch are turned off in the first period, the plurality of seventh switches and the plurality of ninth switches are turned off and the plurality of eighth switches and the tenth switch are turned on in the second period.
